(19) United States
(12) Patent Application Publication
(10) Pub. No.: US 2016/0216705 A1
(43) Pub. Date: Jul. 28, 2016

(54) CONTROL APPARATUS

(71) Applicant: KABUSHIKI KAISHA TOSHIBA, Tokyo (JP)

(72) Inventor: Mitsuhiro SHINOHARA, Fuchu Tokyo (JP)

(21) Appl. No.: 14/915,744

(22) PCT Filed: Apr. 15, 2015
(86) PCT No.: PCT/JP2015/061627

§ 371 Date: Mar. 1, 2016

(30) Foreign Application Priority Data
Apr. 21, 2014 (JP) 2014-087637

(51) Int. Cl. G05B 19/05

(52) U.S. Cl. CPC G05B 19/054; G05B 2219/1105; G05B 2219/14073

(57) ABSTRACT

A control apparatus of an embodiment controls an external device. The control apparatus includes a first storage, a second storage, and a controller. The first storage includes a first area that can store first information for controlling the external device. The second storage stores software that can access the first area. The controller executes the software stored in the second storage. The software identifies a model of the control apparatus and accesses the first area according to an address of the first area in the first storage included in the control apparatus of the model, the address being stored in association with the identified model in a database that stores the model of the control apparatus and the address in association with each other.

### FIELD

Embodiments of the present invention relate to a control apparatus.

### BACKGROUND

A central processing unit (CPU) module of a control apparatus such as a controller and a programmable logic controller (PLC) assigns storage areas to a storage. The storage areas can store input/output (I/O) variables for controlling an external device such as an I/O module connected to the CPU module.

### CITATION LIST

### Patent Literature

Patent Literature 1: Japanese Patent Application Laid-open No. 2013-142933

### SUMMARY OF THE INVENTION

### Problem to be Solved by the Invention

The number of external devices that the control apparatus can control varies depending on the capacity of the storage included in the control apparatus. Therefore, a control apparatus having a storage of a different capacity is considered a different model. Accordingly, regarding software such as firmware provided in the control apparatus to execute the same processing functions, it requires a different memory management method (for example, allocation of storage areas to the storage, in which I/O variables are stored) depending on the capacity of the storage of the control apparatus. Because of this, different kinds of software are manufactured and managed for different models of control apparatus.

Furthermore, conventionally, it is necessary to separately make a change, such as addition or modification of a function, to two pieces of software with the same processing functions installed in different models of control apparatuses. Therefore, there is a possibility that a difference occurs erroneously between the changes performed on the two pieces of software and the same change operation needs to be performed twice, thus increasing the amount of operation. As a result, the management of the software becomes complicated.

### Means for Solving Problem

In general, according to an embodiment, a control apparatus that controls an external device, and that comprises a first storage, a second storage, and a controller. The first storage includes a first area capable of storing first information for controlling the external device. The second storage stores software capable of accessing the first area. The controller executes the software stored in the second storage. The software identifies a model of the control apparatus and accesses the first area according to an address of the first area in the first storage included in the control apparatus of the model, the address being stored in association with the identified model in a database that stores the model of the control apparatus and the address in association with each other.

### BRIEF DESCRIPTION OF DRAWINGS

FIG. 1 is a block diagram illustrating a configuration of a controller according to a first embodiment,

FIG. 2A is a diagram for explaining an access operation to an I/O variable area by firmware included in the controller according to the first embodiment.

FIG. 2B is a diagram for explaining the access operation to the I/O variable area by the firmware included in the controller according to the first embodiment.

FIG. 3 is a flowchart of the access operation to the I/O variable area by the firmware included in the controller according to the first embodiment.

FIG. 4A is a diagram for explaining an access operation to an I/O variable area by firmware included in a controller according to a second embodiment.

FIG. 4B is a diagram for explaining the access operation to the I/O variable area by the firmware included in the controller according to the second embodiment.

FIG. 5A is a diagram for explaining an access operation to an I/O variable area by firmware included in a controller according to a third embodiment.

FIG. 5B is a diagram for explaining the access operation to the I/O variable area by the firmware included in the controller according to the third embodiment.

### DETAILED DESCRIPTION

Hereinafter, a controller to which a control apparatus according to an embodiment is applied will be described with reference to the attached drawings.

### First Embodiment

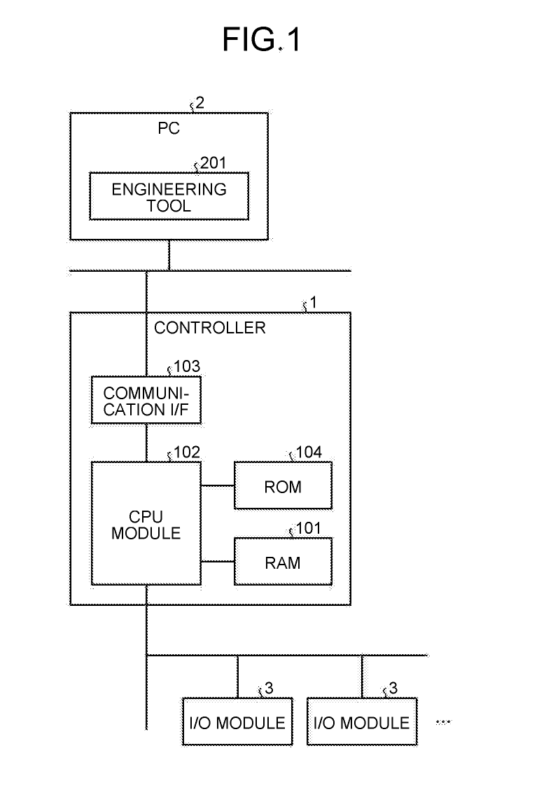

FIG. 1 is a block diagram illustrating a configuration of a controller according to a first embodiment. In the present embodiment, a controller 1 is an example of a control apparatus that controls I/O modules 3 (an example of an external device) which is a control target. As illustrated in FIG. 1, it includes a random access memory (RAM) 101, a central processing unit (CPU) module 102, a communication I/F 103, and a read only memory (ROM) 104.

The communication I/F 103 is an interface connected through a network such as Ethernet (registered trademark) to a host device and can communicate with the host device. The host device is exemplified by a personal computer (PC) 2 including an engineering tool 201 that controls the entire information processing system including the controller 1.

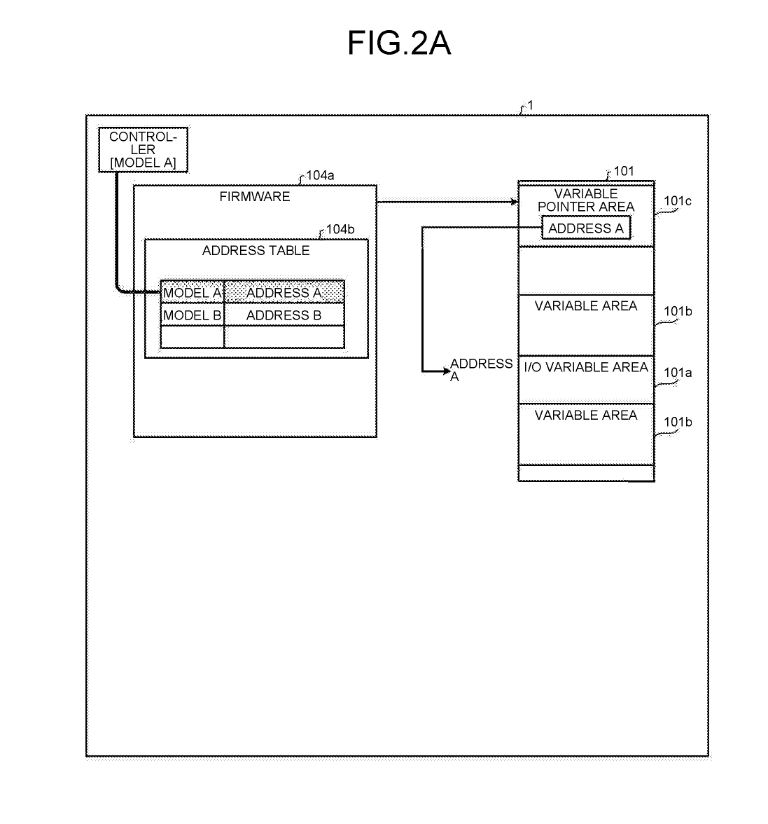

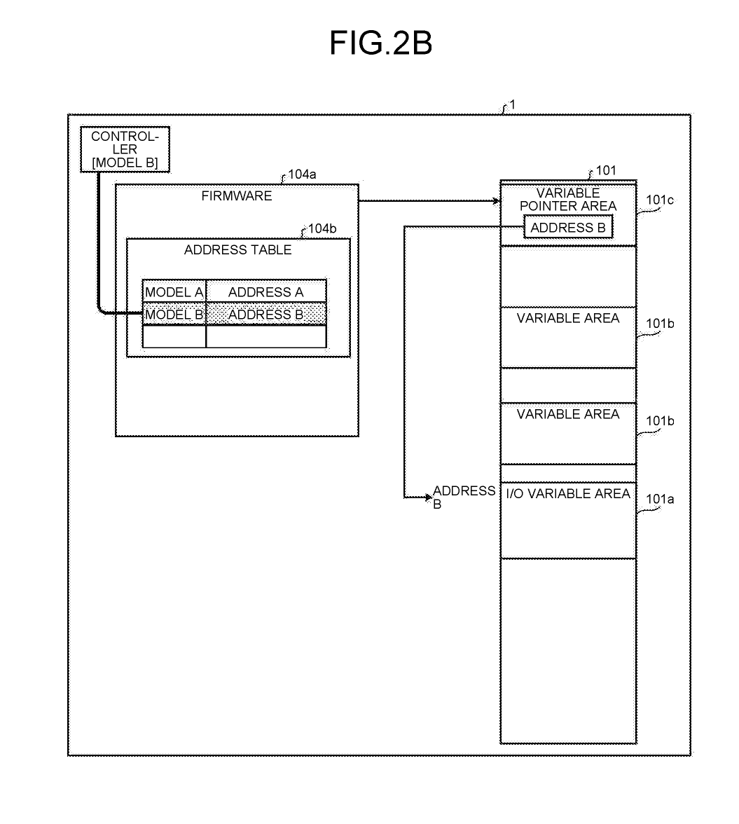

The RAM 101 functions as a work area of the CPU module 102 as described later. Specifically, the RAM 101 (an example of a first storage) includes an I/O variable area 101a (see FIGS. 2A and 2B, an example of a first area) which can store I/O variables (an example of first information) for controlling the I/O modules 3. In the present embodiment, the RAM 101 includes a variable area 101b (see FIGS. 2A and 2B) that can store variables other than the I/O variables, and a variable pointer area 101c (see FIGS. 2A and 2B, an example of a predetermined second area) that can store an address of the I/O variable area 101a (hereinafter referred to as an I/O variable address).

The ROM 104 (an example of a second storage) stores various kinds of programs including firmware 104a (see FIGS. 2A and 2B, an example of software) which is executed by the later-described CPU module 102 to access the I/O variable area 101a of the RAM 101 (see FIGS. 2A and 2B) (for example, write and read an I/O variable to/from the I/O variable area 101a) and an operating system (OS).

The ROM 104 also stores an address table 104b (see FIGS. 2A and 2B, an example of database) which associates model information (for example, a model name) that can identify the model of the controller 1 with an I/O variable address as an address of the I/O variable area 101a (see FIGS. 2A and 2B) in the RAM 101 of the controller 1 of the model identified by the model information.

The CPU module 102 controls the entire controller 1. Specifically, the CPU module 102 controls the respective elements including such as the RAM 101 and the ROM 104 connected through a bus.

The CPU module 102 is connected to the I/O modules 3 controlled by the controller 1. The CPU module 102 (an example of a controller) accesses the I/O variable area 101a (see FIGS. 2A and 2B) of the RAM 101 by executing the firmware 104a (see FIGS. 2A and 2B) stored in the ROM 104.

Here, an access operation to the I/O variable area 101a by the firmware 104a provided in the controller 1 according to the present embodiment will be described with reference to FIGS. 2A and 2B. FIGS. 2A and 2B are diagrams for explaining the access operation to the I/O variable area by the firmware in the controller according to the first embodiment.

The capacity of the RAM 101 mounted on the controller 1 differs depending on the model of the controller 1 (the number of I/O modules as the number of the I/O modules 3 connected to the CPU module 102, in other words, the number of external devices controlled by the controller 1). For example, when the number of I/O modules controlled by the controller 1 of model A is 1 and the number of I/O modules controlled by the controller 1 of model B is 5, the capacity of the RAM 101 of the model A is smaller than the capacity of the RAM 101 of the model B as illustrated in FIGS. 2A and 2B. Accordingly, as illustrated in FIGS. 2A and 2B, the capacity of the I/O variable area 101a in the RAM 101 of the model A is smaller than the capacity of the I/O variable area 101a in the RAM 101 of the model B.

However, the processing functions of the CPU module 102 of the model A and the CPU module 102 of the model B are the same, so that the capacities and the addresses of the variable areas 101b that can store variables other than the I/O variables are the same between the type A and the type B, as illustrated in FIGS. 2A and 2B. Therefore, the respective I/O variable areas 101a of the model A and the model B cannot be set in the same areas of the RAMs 101, as illustrated in FIGS. 2A and 2B.

In a conventional controller, different firmware for different models of controllers are designed, so that access to the I/O variable areas different for is realized. However, it is necessary to design different firmware for different models of the controllers.

Furthermore, conventionally, it is necessary to separately make a change, including addition or modification of a function, to two pieces of firmware with the same processing function and installed in different models of controllers . Therefore, a difference between the changes to the two pieces of firmware may occur erroneously and the same change needs to be repeated twice, thus increasing the workload and complicating the firmware management.

In view of this, the controller 1 according to the present embodiment, the firmware 104a executed by the CPU module 102 identifies the model of the controller 1 in which the firmware 104a is installed and accesses the I/O variable area 101a of the RAM 101 according to an I/O variable address which is stored in association with model information on the identified model in an address table 104b in the ROM 104.

Thereby, according to the controller 1 of the present embodiment, it is unnecessary to design different pieces of firmware 104a for different models of the controller 1 for the purpose of accessing the I/O variable areas 101a different for different models. Further, it is possible to access the I/O variable areas 101a of different models of the controller 1 by the same firmware 104a.

Furthermore, according to the controller 1 of the present embodiment, to make various changes such as addition and modification of functions to the firmware 104a of the controllers 1 of different models, the same changes can be made thereto. This makes it possible to reduce errors in the changes to the firmware 104a and the workload thereof and uniformly manage the firmware 104a.

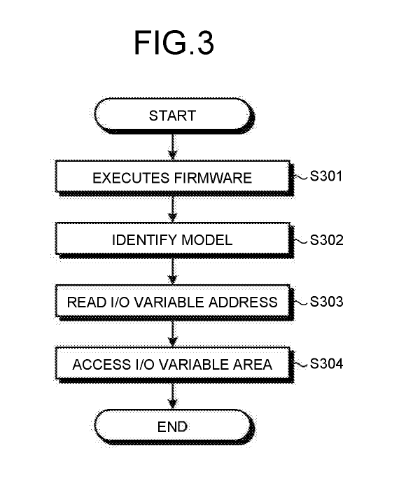

Next, an access operation to the I/O variable area 101a in the controller 1 according to the present embodiment will be described with reference to FIGS. 2A, 2B, and 3. FIG. 3 is a flowchart of the access operation to the I/O variable area by the firmware included in the controller according to the first embodiment.

In the present embodiment, the CPU module 102 executes the firmware 104a stored in the ROM 104 upon startup of the controller 1 (step S301). The firmware 104a identifies the model of the controller 1 according to a signal (hereinafter referred to as a hardware signal) output from hardware in the controller 1 at the startup of the controller 1 (step S302).

In the present embodiment, the firmware 104a identifies the model of the controller 1 based on the hardware signal. However, it should not be limited thereto. For example, the firmware 104a may identify the model of the controller 1 based on model information input from a not-shown operation unit of the controller 1 or from the PC 2 through the communication I/F 103.

Subsequently, after the startup of the controller 1, prior to accessing the I/O variable area 101a, the firmware 104a reads an I/O variable address associated with the model identified in step 5302 from the address table 104b stored in the ROM 104 (step S303). In the present embodiment, the firmware 104a reads the I/O variable address from a storage of the controller 1 (the address table 104b stored in the ROM 104). However, it should not be limited thereto. For example, the firmware 104a can read the I/O variable address from the address table 104b stored in an external storage provided in the PC 2.

Then, the firmware 104a writes the read I/O variable address to the variable pointer area 101c (an example of a predetermined second area) in the RAM 101. Thereby, it is possible to access the I/O variable area 101a with the I/O variable address stored in the variable pointer area 101c. Since it is not necessary to read the I/O variable address from the address table 104b every time the I/O variable area 101a is accessed, the processing load from the accesses to the I/O variable area 101a can be reduced.

For example, as illustrated in FIG. 2A, when the model A is identified based on the hardware signal, the firmware 104a reads an address A, which is an I/O variable address associated with the model A, from the address table 104b. Then, as illustrated in FIG. 2A, the firmware 104a writes the address A, which is the read I/O variable address, to the variable pointer area 101c in the RAM 101.

On the other hand, as illustrated in FIG. 2B, when the model B is identified based on the hardware signal, the firmware 104a reads an address B, which is an I/O variable address associated with the model B, from the address table 104b. Then, as illustrated in FIG. 2B, the firmware 104a writes the read address B, which is the read I/O variable address, to the variable pointer area 101c in the RAM 101.

Returning to FIG. 3, to access the I/O variable area 101a to control an external device connected to the I/O modules 3, the firmware 104a first accesses the variable pointer area 101c in the RAM 101 and reads the I/O variable address. Then, the firmware 104a accesses the I/O variable area 101a in accordance with the read I/O variable address (step S304). In other words, by accessing the I/O variable area 101a by the I/O variable address read from the address table 104b, it is possible to access the I/O variable area 101a different for each of the controller 1 without designing different firmware 104a for each model of the controller 1, so that it is possible to access the I/O variable area 101a by the same firmware 104a even when the model of the controller 1 varies.

For example, as illustrated in FIG. 2A, the firmware 104a of the model A accesses the variable pointer area 101c in the RAM 101 and reads the address A which is the I/O variable address, Then, the firmware 104a accesses the I/O variable area 101a according to the address A which is the read I/O variable address. Meanwhile, as illustrated in FIG. 2B, the firmware 104a of the model B accesses the variable pointer area 101c in the RAM 101 and reads the address B which is the I/O variable address. Then, the firmware 104a accesses the I/O variable area 101a according to the address B which is the read I/O variable address.

In the present embodiment, the firmware 104a accesses the I/O variable area 101a with the I/O variable address which is written to the variable pointer area 101c in advance at the startup of the controller 1. However, it should not be limited thereto as long as the firmware 104a accesses the I/O variable area 101a with the I/O variable address read from the ROM 104. For example, when accessing the I/O variable area 101a, the firmware 104a may access the I/O variable area 101a by reading the I/O variable address from the ROM 104 and using the read I/O variable address.

As described above, according to the controller 1 of the first embodiment, it is not necessary to design different pieces of firmware 104a for the different models of the controller 1 for the purpose of accessing the I/O variable areas 101a different for the different models. The accesses to the I/O variable area 101a of a different model controller 1 can be implemented by the same firmware 104a.

### Second Embodiment

The present embodiment will describe an example in which the RAM includes a plurality of I/O variable areas provided for respective types of I/O variable, the address table stores addresses of I/O variable areas corresponding to the types of the I/O variable in association with the models of the controller, and the firmware accesses an I/O variable area according to an I/O variable address which is stored, in the address table, in association with the model of the controller and corresponds to the type of the I/O variable to be read and/or written by access to the I/O variable area. In the following, the same or like description as that in the first embodiment will be omitted.

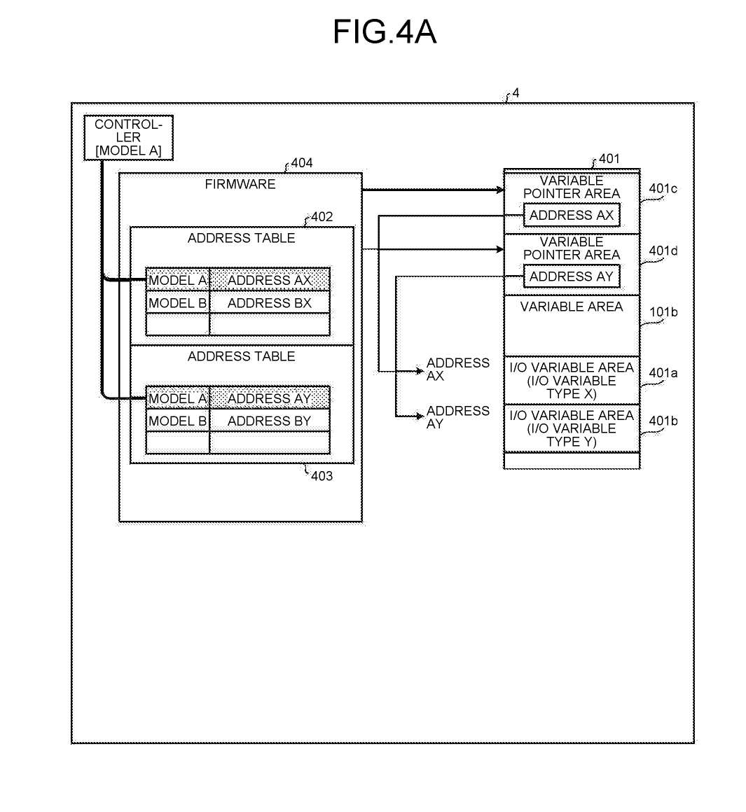

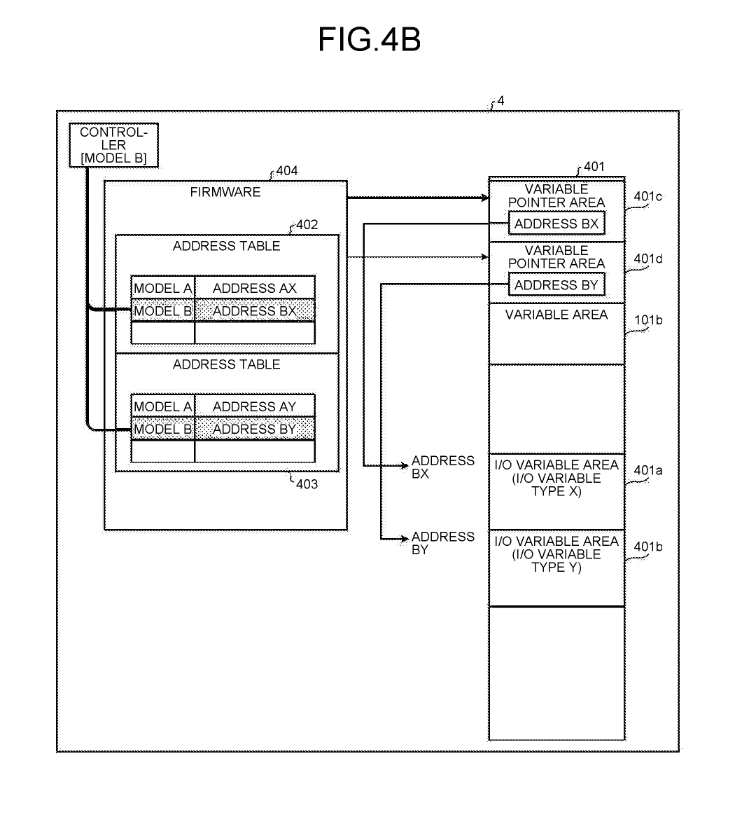

FIGS. 4A and 4B are diagrams for explaining an access operation to the I/O variable area by the firmware included in the controller according to the second embodiment. As illustrated in FIGS. 4A and 4B, a controller 4 according to the present embodiment includes an RAM 401 which includes a plurality of (in the present embodiment, two) I/O variable areas 401a and 401b provided for respective types of I/O variables (for example, a data format of I/O variable, I/O modules 3 controlled according to I/O variables). Furthermore, in the present embodiment, as illustrated in FIGS. 4A and 4B, the RAM 401 includes a plurality of (in the present embodiment, two) variable pointer areas 401c and 401d provided for the respective I/O variable types.

Furthermore, in the present embodiment, the ROM 104 stores a plurality of (in the present embodiment, two) address tables 402 and 403 for the respective I/O variable types. Specifically, the address table 402 stores model information by which the model of the controller 4 can be identified and an address of the I/O variable area 401a corresponding to an I/O variable type X. The address table 403 stores model information by which the model of the controller 4 can be identified and an address of the I/O variable area 401b corresponding to an I/O variable type Y. In other words, the address tables 402 and 403 function as a database that stores an address of an I/O variable area corresponding to each I/O variable type in association with the model of the controller 4 by way of example.

In the present embodiment, after the startup of the controller 4, prior to accessing the I/O variable areas 401a and 401b, a firmware 404 reads I/O variable addresses of I/O variable types associated with the identified model from the address tables 402 and 403 stored in the ROM 104, respectively. Subsequently, the firmware 404 writes the read I/O variable addresses of I/O variable types to the variable pointer areas 401c and 401d provided for the respective I/O variable types.

For example, when the controller 4 identified based on the hardware signal is the model A and the I/O variable which will be read and/or written is the I/O variable type X, as illustrated in FIG. 4A, the firmware 404 reads an address AX, which is an I/O variable address associated with the model A, from the address table 402 corresponding to the I/O variable type X. Then, as illustrated in FIG. 4A, the firmware 404 writes the address AX, which is the read I/O variable address, to the variable pointer area 401c corresponding to the I/O variable type X.

On the other hand, when the controller 4 identified based on the hardware signal is the model A and the I/O variable which will be read and/or written is the I/O variable type Y, as illustrated in FIG. 4A, the firmware 404 reads an address AY, which is an I/O variable address associated with the model A, from the address table 403 corresponding to the I/O variable type Y. Then, as illustrated in FIG. 4A, the firmware 404 writes the read address AY, which is the read I/O variable address, to the variable pointer area 401d corresponding to the I/O variable type Y.

Furthermore, when the controller 4 identified based on the hardware signal is the model B and the I/O variable which will be read and/or written is the I/O variable type X, as illustrated in FIG. 4B, the firmware 404 reads an address BX, which is an I/O variable address associated with the model B, from the address table 402 corresponding to the I/O variable type X. Then, as illustrated in FIG. 4B, the firmware 404 writes the address BX, which is the read I/O variable address, to the variable pointer area 401c corresponding to the I/O variable type X.

On the other hand, when the controller 4 identified based on the hardware signal is the model B and the I/O variable which will be read and/or written is the I/O variable type Y, as illustrated in FIG. 4B, the firmware 404 reads an address BY, which is an I/O variable address associated with the model B, from the address table 403 corresponding to the I/O variable type Y. Then, as illustrated in FIG. 4B, the firmware 404 writes the address BY, which is the read I/O variable address, to the variable pointer area 401d corresponding to the I/O variable type Y.

For accessing the I/O variable areas 401a and 401b, the firmware 404 reads I/O variable addresses from the variable pointer areas 401c and 401d corresponding to the I/O variable type of an I/O variable which is written and/or read by the access. In other words, the firmware 404 reads the I/O variable addresses corresponding to the I/O variable type of the I/O variable which is written and/or read from the address tables 402 and 403. Thereafter, the firmware 404 accesses the I/O variable areas 401a and 401b based on the read I/O variable addresses.

As described above, according to the controller 4 of the second embodiment, the RAM 401 includes the variable areas 401a and 401b provided for respective types of I/O variable. However, as in the first embodiment, it is unnecessary to design different pieces of firmware 404 for the different models of the controller 4 for the purpose of accessing the different I/O variable areas 401a and 401b for the different models. The I/O variable areas 401a and 401b can be accessed by the same firmware 404 even when the model of the controller 4 differs, Furthermore, to make various changes such as addition and modification of functions to the firmware 404 of the controllers 4 of different models, the same changes may be made thereto. This makes it possible to reduce errors in the changes and the workload thereof and uniformly manage the firmware 404.

### Third Embodiment

The present embodiment will describe an example in which I/O module registration information (an example of second information) for identifying the model of the controller is received from a host device and the model of the controller is identified on the basis of the received I/O module registration information. In the following, the same or like descriptions as those in the first and second embodiments will be omitted.

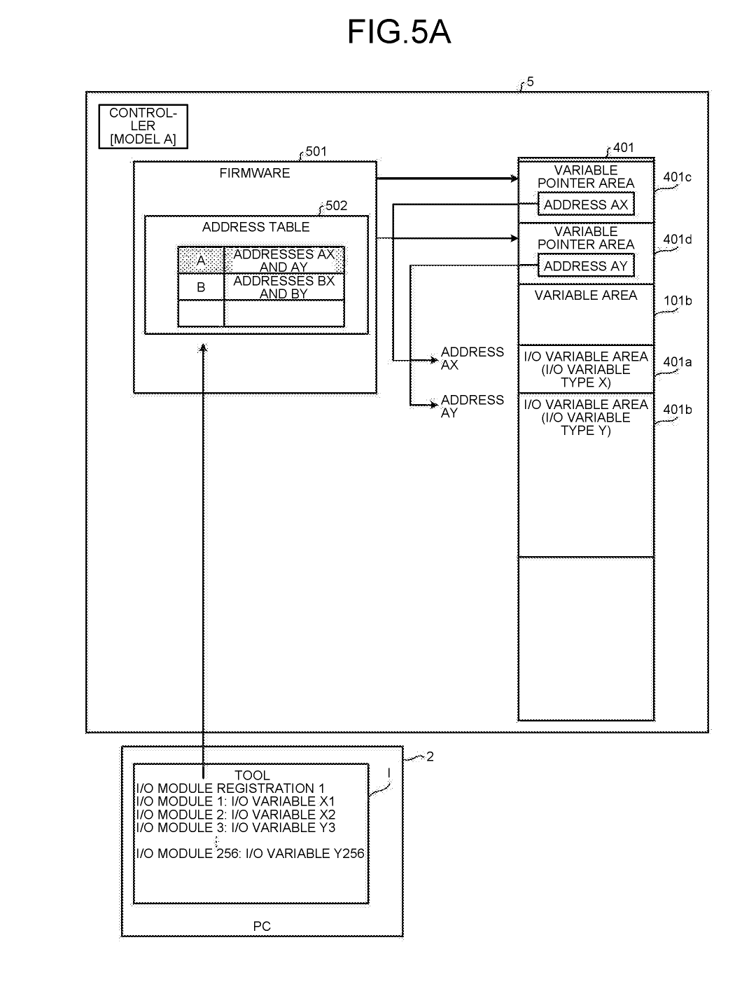

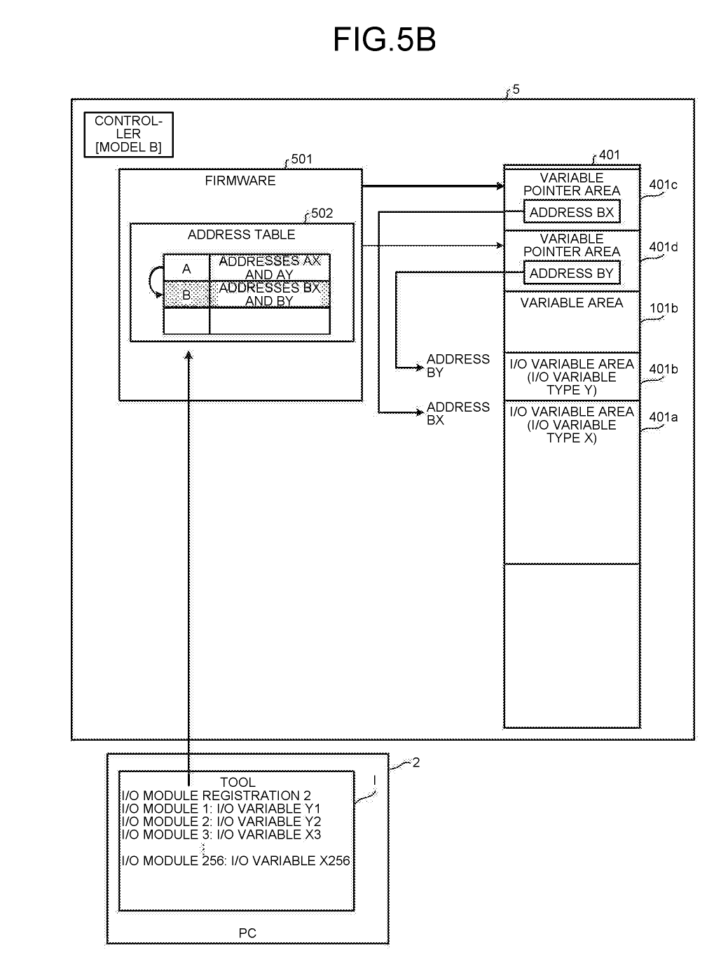

FIGS. 5A and 5B are diagrams for explaining an access operation to the I/O variable area by the firmware included in the controller according to the third embodiment. A controller 5 according to the present embodiment includes the ROM 104 which stores an address table 502 that associates model information by which the model of the controller 5 can be identified with addresses of the I/O variable areas 401a and 401b corresponding to respective I/O variable types.

In the present embodiment, after the startup of the controller 5, prior to accessing the I/O variable areas 401a and 401b, a firmware 501 receives I/O module registration information I by which the model of the controller 5 can be identified, from the PC 2 (an example of a host device) through the communication I/F 103.

In the present embodiment, when detecting the startup of the controller 5, the engineering tool 201 of the PC 2 transmits the I/O module registration information I to the controller 5. Herein, as described above, the I/O module registration information I is for identifying the model of the controller 5 whose startup has been detected, for example, a magnitude relation between the number of I/O variables of the I/O variable type X and the number of I/O variables of the I/O variable type Y for controlling the I/O modules 3.

Then, the firmware 501 identifies the model of the controller 5 on the basis of the I/O module registration information I received from the PC 2. For example, when the received I/O module registration information I indicates that the number of I/O variables of the I/O variable type X is smaller than the number of I/O variables of the I/O variable type Y, the firmware 501 identifies the controller 5 as the model A as illustrated in FIG. 5A. Subsequently, as illustrated in FIG. 5A, the firmware 501 reads the addresses AX and AY which are I/O variable addresses associated with the identified model A from the address table 502 stored in the ROM 104. Then, as illustrated in FIG. 5A, the firmware 501 writes the read addresses AX and AY, which are the read I/O variable addresses corresponding to the respective I/O variable types, to the variable pointer areas 401c and 401d corresponding to the respective I/O variable types.

Thereafter, to access the I/O variable area 401a where the I/O variable of the I/O variable type X is stored, as illustrated in FIG. 5A, the firmware 501 accesses the I/O variable area 401a based on the address AX which is the I/O variable address stored in the variable pointer area 401c. On the other hand, to access the I/O variable area 401b where the I/O variable of the I/O variable type Y is stored, as illustrated in FIG. 5A, the firmware 501 accesses the I/O variable area 401b based on the address AY which is the I/O variable address stored in the variable pointer area 401d.

Furthermore, when the received I/O module registration information I indicates that the number of I/O variables of the I/O variable type X is greater than the number of I/O variables of the I/O variable type Y, the firmware 501 identifies the controller 5 as the model B as illustrated in FIG. 5B. Subsequently, as illustrated in FIG. 5B, the firmware 501 reads the addresses BX and BY which are I/O variable addresses associated with the identified model B from the address table 502 stored in the ROM 104. Then, as illustrated in FIG. 5B, the firmware 501 writes the read addresses BX and BY, which are the read I/O variable addresses corresponding to the respective I/O variable types, to the variable pointer areas 401c and 401d corresponding to the respective I/O variable types.

Thereafter, to access the I/O variable area 401a where the I/O variable type X is stored, the firmware 501 accesses the I/O variable area 401a based on the address BX which is the I/O variable address stored in the variable pointer area 401c. On the other hand, to access the I/O variable area 401b in which the I/O variable type Y is stored, the firmware 501 accesses the I/O variable area 401b based on the address BY which is the I/O variable address stored in the variable pointer area 401d.

As described above, according to the controller 5 of the third embodiment, for identifying the model of the controller 5 on the basis of the I/O module registration information I received from the PC 2, it is not necessary to design different pieces of firmware 501 for the different models of the controller 5 for the purpose of accessing the different I/O variable areas 401a and 401b for the different models, as in the first embodiment. The I/O variable areas 401a and 401b can be accessed by the same firmware 501 even when the model of the controller 5 differs. Furthermore, to make various changes such as addition and modification of functions to the pieces of firmware 501 of the controller 5 of different models, the same changes can be thereto. This makes it possible to reduce errors in the changes and the workload thereof and uniformly manage the firmware 501,

As described above, according to the first to third embodiments, the same firmware can access the I/O variable areas of different models of controllers.

The programs executed by the controller 1, 4, or 5 of the present embodiments are pre-stored in the ROM 104. However, the programs may be recorded on a computer-readable recording medium such as a CD-ROM, a flexible disk (FD), a CD-R, and a digital versatile disk (DVD) in an installable or executable file format.

Furthermore, the programs executed by the controller 1, 4, or 5 of the present embodiments may be stored in a computer connected to a network such as the Internet and downloaded through the network. Furthermore, the programs executed by the controller 1, 4, or 5 of the present embodiments may be provided or distributed through a network such as the Internet.

While some embodiments of the present invention have been described, these embodiments are presented as examples and do not intend to limit the scope of the invention. These new embodiments can be implemented in other various forms, and various abbreviations, exchanges, and changes can be made within a scope not deviating from the gist of the invention. These embodiments and their modifications are included in the scope and spirit of the invention and are also included in the inventions described in claims and equivalents thereof,

1. A control apparatus that controls an external device, the control apparatus comprising:
a first storage that includes a first area capable of storing first information for controlling the external device;
a second storage that stores software capable of accessing the first area; and
a controller that executes the software stored in the second storage,
wherein the software identifies a model of the control apparatus and accesses the first area according to an address of the first area in the first storage included in the control apparatus of the model, the address being stored in association with the identified model in a database that stores the model of the control apparatus and the address in association with each other.

2. The control apparatus according to claim 1, wherein after startup of the control apparatus, prior to accessing the first area, the software reads the address stored in association with the identified model from the database, writes the address to a predetermined second area of the first storage, and accesses the first area according to the address stored in the second area.

3. The control apparatus according to claim 1, wherein
the first storage includes a plurality of first areas provided for respective types of the first information,
the database stores addresses of the first areas in association with the models of the control apparatus, the addresses corresponding to the respective types of the first information, and
the software accesses the first area according to the address which is stored in association with the identified model and which corresponds to the types of the first information at least written or read by an access to the first area in the database.

4. The control apparatus according to claim 1, wherein the software receives second information from a host device and identifies the model of the control apparatus based on the received second information, the second information being information capable of identifying the model of the control apparatus.
